(19) United States
(12) Patent Application Publication
(10) Pub. No.: US 2017/0234969 A1
(43) Pub. Date: Aug. 17, 2017

(54) RADAR DEVICE

(71) Applicant: MAZDA MOTOR CORPORATION, Hiroshima (JP)

(72) Inventors: Ryota MITOTE, Kure-shi (JP); Hideki KOBAMBA, Hiroshima-shi (JP); Akihiro HISATSUNE, Higashihiroshima-shi (JP); Shumpei TAKESHITA, Hiroshima-shi (JP); Hiroya UCHIDA, Hiroshima-shi (JP); Yuki OKAMOTO, Hiroshima-shi (JP)

(73) Assignee: MAZDA MOTOR CORPORATION, Hiroshima (JP)

(21) Appl. No.: 15/411,229

(22) Filed: Jan. 20, 2017

(30) Foreign Application Priority Data
Feb. 15, 2016 (JP) 2016-025582

(51) Int. Cl. G01S 7/292; G01S 13/93

(52) U.S. Cl. CPC G01S 7/2921; G01S 13/931

(57) ABSTRACT

A radar device 10, mounted on a vehicle A, for repeatedly performing a measurement of a target at every predetermined measurement interval, comprising a transmitting and receiving part 14 for, in each of the measurement events, transmitting a measurement wave P, and receiving a reflection wave R thereof as a detection wave, and a controller 12 for controlling the transmitting and receiving part 14, wherein the controller 12 is configured to control the transmitting and receiving part 14 so that at least one of a length (T₁, T₂) of each of the measurement intervals and a signal strength (I₁, I₂) of each of the measurement waves P is changed with time.

### TECHNICAL FIELD

The present invention relates to a radar device, and more particularly to a radar device which repeatedly perform measurements of a target at every predetermined measurement interval.

### BACKGROUND

Conventionally, a vehicle is typically provided with a radar device which uses a millimeter-wave radar, for example, for detecting a target or an obstacle (such as another vehicle, a structural object, a pedestrian and so on) outside the vehicle. The radar device is configured to transmit a measurement wave of a predetermined frequency, and by receiving a reflection wave thereof, a relative distance and/or relative speed between the vehicle and the target can be measured. Such radar device is used in a drive assist system etc. of a vehicle (for example, refer to Patent Document 1: JP2009-230464A).

In the radar device, a distance between the vehicle and a target can be calculated by making use of the fact that there is a time delay from the time when the measurement wave is transmitted for reflection by the target, and to the time when it comes back as the reflection wave. Further, the radar device is configured as to receive the reflection wave in a measurement period or receiving window from the time when the measurement wave is transmitted to the time when a predetermined reception available time is passed. When a target is present within a predetermined distance range from the vehicle, the reflection wave is received within the measurement period, and thus, the distance between the vehicle and the target is calculated. On the other hand, when there is no target present within the predetermined distance range from the vehicle, no significant reflection wave is received within the measurement period.

Such measurement is performed at every predetermined measurement interval. Specifically, the measurement wave is transmitted at every measurement interval, and the reflection wave is allowed to be received within the measurement period from the time when the measurement wave is transmitted. Therefore, the radar device is configured so that the measurement is repeatedly performed at every fixed predetermined interval.

### SUMMARY

### Technical Problem

However, if a noise wave arrives at the vehicle, the radar device may erroneously detect the noise wave as the reflection wave, and based on the erroneous noise wave, calculates the relative distance and/or the relative speed etc. between the vehicle and the target which does not exist. In addition, for example, when the calculated distance is short, the drive assist system may be erroneously activated in order to avoid possible accident. For example, an alarm may be triggered to inform the driver that a vehicle is approaching, or a braking device may be actuated.

Further, in a case wherein a single noise wave arrives, since the noise wave is erroneously detected only once during successive measurement events, and not detected in other measurement events by the radar device, it may be possible to differentiate the error detection (that is to say, differentiate the noise wave). However, in the case where the noise wave arrives on a periodic basis, and also an arriving interval of the noise wave corresponds with the measurement interval of the radar device, the noise wave may be measured continuously by the radar device. Thus, the noise wave cannot be differentiated, and it may be detected in error as the reflection wave.

As described above, in the radar device of a vehicle, there has been a problem that an electric wave transmitted from other vehicle and/or other structural object etc. on a regular basis becomes such noise wave to cause the erroneous or incorrect detection by the radar device, and/or the erroneous or incorrect actuation of other system related thereto.

The present invention has been made to solve the above conventional problems, and an object thereof is to provide a radar device capable of avoiding erroneous or incorrect detection due to a noise signal received on a regular basis.

### Solution to Technical Problem

In order to achieve the above object, according to the present invention, there is provided a radar device, adapted to be mounted on a vehicle, for repeatedly performing a measurement of a target at every predetermined measurement interval, comprising a transmitting and receiving part for, in each of the measurement events, transmitting a measurement wave which lasts for a predetermined transmission period shorter than the measurement interval within the measurement interval, and receiving a reflection wave thereof as detection waves, and a controller for controlling the transmitting and receiving part, wherein the controller is configured to control the transmitting and receiving part so that at least one of a length of each of the measurement intervals and a signal strength of each of the measurement waves is changed with time.

According to the present invention having the above features, the length of each of the measurement interval (the transmission interval) or signal strength of each of the measurement waves are changed with time. Thus, in a case where the length of each of the measurement interval is changed with time, the radar device receives the reflection waves, which is what returned from the target as a result of the measurement waves being reflected by the target, on unequal intervals instead of on fixed intervals in terms of time, according to the change of the length of each of the measurement interval. On the other hand, if each of the measurement intervals is unequal in terms of time, in a plurality of measurements, the noise wave which arrives on a fixed cycle from outside may be received in one measurement, but not in another measurement, and thus, the measurement where the reflection wave is received and the measurement where the reflection wave is not received may both exist. Alternatively, there may be produced a condition, in which a delay time of receiving the noise wave from the time when the measurement wave is transmitted is meaningfully deviated from a measurement event to another measurement event. Thus, in accordance with the present embodiment, it is possible to determine as to whether or not the detection waves are the noise waves which arrive on a periodic basis to prevent the erroneous detection of the noise waves, by monitoring whether the reception waves (detection waves) are received or not, or by monitoring the delay time for reception.

In addition, in a case where the signal strengths of the measurement waves are changed with time, the signal strengths of the reflection waves from the target change in accordance with the change of the signal strengths of the measurement waves, but the signal strengths of the noise waves do not change in accordance with the changes of the signal strengths of the measurement waves. Thus, in accordance with the present embodiment, it is possible to determine as to whether the detection waves are the noise waves or not to thereby prevent the erroneous detection of the noise waves, by monitoring the signal strength of each of the reception waves (detection waves) with respect to the signal strength of each of the measurement waves.

In addition, according to the present invention, preferably, the controller is configured to control the transmitting and receiving part so that the length of each of the measurement intervals is be changed with time, said controller is configured such that when results of successive measurement events of at least three times in which the length of the measurement intervals are changed include both a measurement result in which the detection wave is received and a measurement result in which the detection wave is not received, the controller determines the received detection wave as a noise wave.

According to the present invention having the above features, each of the reflection waves is received in all of the measurement events in the measurements of at least three times in which the length of each of the measurement intervals is changed, but since each of the noise waves which arrives on a fixed cycle is not always received in all of the measurement events, it is possible to easily determine as to whether the detection wave is the noise wave or not, by monitoring the measurements of a predetermined number of times.

In addition, according to the present invention, preferably, the controller controls the transmitting and the receiving part so that the signal strengths of the measurement waves are changed with time, said controller is configured such that, when the signal strengths of a pair of detection waves received in successive measurement events of at least two times by the transmission of each of the measuring waves having different signal strength are the same, the controller determines the received pair of detection waves as the noise waves.

According to the present invention having the above features, in the pair of measurements of at least two measurement events in which the signal strength of each of the measurement waves is changed, the signal strength of the received pair of the reflection waves is changed according to the change of the signal strength of each of the measurement waves, but since the signal strength of the receive pair of noise waves is not changed even under the change of the signal strength of each of the measurement wave, it is possible to easily determine as to whether the detection waves are the noise waves or not, by monitoring the measurements of a predetermined number of times.

In addition, according to the present invention, preferably, the noise waves are electric waves transmitted on a fixed cycle from another vehicle or from a fixed structural object on a road.

According to the present invention, it is possible to provide the radar device capable of avoiding an erroneous detection due to the noise signal received on a regular basis.

### BRIEF DESCRIPTION OF THE DRAWINGS

FIG. 1 is an illustrative diagram depicting a configuration of a radar device according to one embodiment of the present invention.

FIG. 2 is an illustrative diagram depicting an operating condition of a radar device according to one embodiment of the present invention.

FIG. 3 is an illustrative diagram depicting a driving condition of a vehicle on which a radar device according to one embodiment of the present invention is mounted, together with another vehicle.

FIG. 4 is an illustrative diagram of a measurement by the radar device according to one embodiment of the present invention in the condition of FIG. 3.

FIG. 5 is an illustrative diagram of a measurement by the radar device according to a comparative example.

FIG. 6 is an illustrative diagram depicting a vehicle on which a radar device according to one embodiment of the present invention is mounted, the vehicle being positioned near a fixed structural object on a road.

FIG. 7 is an illustrative diagram of a measurement of a radar device according to one embodiment of the present invention under the condition shown in FIG. 6.

FIG. 8 is an illustrative diagram of a measurement by the radar device according to a comparative example.

FIG. 9 is an illustrative diagram of a measurement by the radar device according to a second embodiment of the present invention in the condition of FIG. 3.

FIG. 10 is an illustrative diagram of a measurement by the radar device according to the second embodiment of the present invention in the condition of FIG. 6.

### DETAILED DESCRIPTION

With reference to the accompanying drawings, one embodiment of the present invention will now be described.

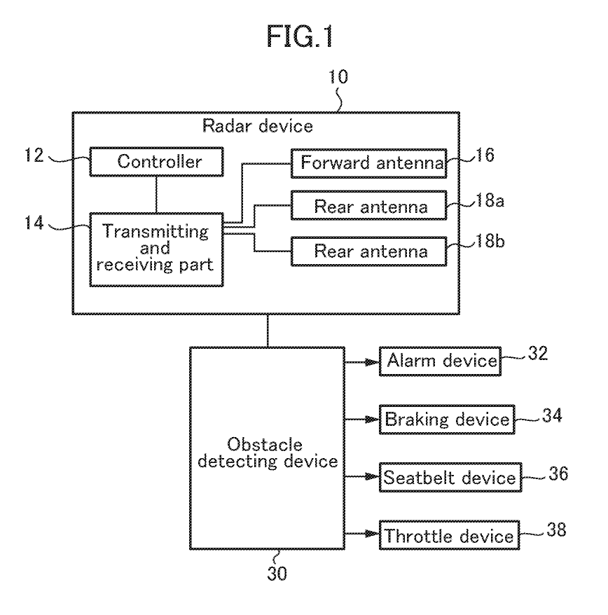

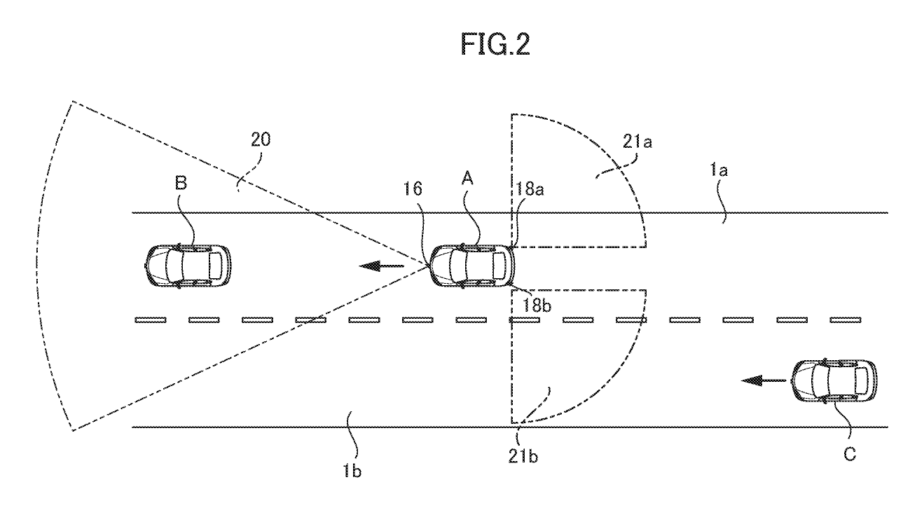

First, a schematic configuration of a radar device of one embodiment of the present invention is described with reference to FIGS. 1 and 2. FIG. 1 is an illustrative diagram depicting a configuration of a radar device, and FIG. 2 is an illustrative diagram depicting an operating condition of a radar device.

A radar device 10 of the present embodiment is a millimeter-wave radar (for example, frequency of 76 GHz to 77 GHz), and configured to transmit a measurement wave which lasts for a short transmission period (for example, 1 millisecond) and receive a reflection wave reflected by a target (for example, another vehicle, a fixed structural object on a road, a pedestrian) to measure a relative distance between the target and the vehicle and/or a relative speed of the target. Further, the vehicle includes not only four-wheel vehicles but also carriers such as two wheel vehicles and/or bicycles. Also, the reflection wave refers to a signal wave which is produced as a result of the measurement wave being reflected at the target.

As shown in FIG. 1, the radar device 10 comprises a controller 12 consisting of CPU etc., a transmitting and receiving part 14 controlled by the controller 12, a forward antenna 16 for measuring a forward area of the vehicle, and rear antennas 18a, 18b for measuring lateral and rearward areas at each of left and right sides of the vehicle. Further, the radar device 10 may be an infrared ray radar, an ultrasonic radar, and/or a microwave radar. In addition, the antenna may be a bidirectional, transmitting and receiving antenna, or separately provided transmitting and receiving antennas.

The transmitting and receiving part 14 is configured as including a voltage control oscillator, a coupler, a mixer, an amplifier, and a filter circuit etc., and based on a transmission command from the controller 12, outputs the measurement waves from the forward antenna 16 and the rear antennas 18a, 18b, and also outputs to the controller 12 processed signals acquired by processing detection waves received by these antennas and the measurement waves.

The controller 12 outputs the transmission command to the transmitting and receiving part 14 to cause the transmitting and receiving part 14 to transmit the measurement waves, and calculates the relative distance and the relative speed with respect to the target based on the processed signals received from the transmitting and receiving part 14.

The radar device 10 outputs the calculated information of the target (such as a distance, speed etc.) to an obstacle detecting device 30. The obstacle detecting device 30 which constitutes a drive assist system is connected to an alarm device 32, a braking device 34, a seatbelt device 36, a throttle device 38 etc. The alarm device 32 informs a driver of any abnormal condition and/or a warning by lighting a lamp, producing a sound from a speaker, a display on a display panel, etc.

The obstacle detecting device 30 functions to actuate the alarm device 32, the braking device 34, the seatbelt device 36, the throttle device 38 etc. as necessary based on the received information of the target. For example, if the obstacle detecting device 30 determines that there is a danger of the vehicle colliding with the target (another vehicle etc.) based on the information of the target, the obstacle detecting device 30 activates the alarm device 32 to produce information on the danger, actuates the braking device 34 to apply a braking force, operates an associated motor of the seatbelt device 36 for increasing tension of the seatbelt, and controls the throttle device 38 to change the throttle position of the throttle device 38 etc.

FIG. 2 depicts a condition where a vehicle A, on which the radar device 10 is mounted, is being driven on a lane 1a in a straight line. Here, the radar device 10 uses the forward antenna 16 to send electric waves (measurement waves) toward a measurement range 20 of the forward area of the vehicle A, and also uses the respective rear antennas 18a. 18b to send electric waves (measurement waves) toward a measurement range 21a of a right rearward area, and a measurement range 21b of a left rearward area, of the vehicle A. The measurement range 20 covers a far area (for example, as far as 200 m), but the measurement ranges 21a, 21b cover a close range compared to the measurement range 20.

In the condition shown in FIG. 2, since a leading vehicle B is running within the forward measurement range 20, the radar device 10 can detect the leading vehicle B. On the other hand, since there is no vehicle driving within the rearward measurement ranges 21a, 21b, the radar device 10 does not detect any presence of a vehicle coming behind within the left and right rearward measurement areas. Further, although a vehicle C is coming behind on an adjacent lane 1b, the behind vehicle C is outside the measurement ranges 21a, 21b.

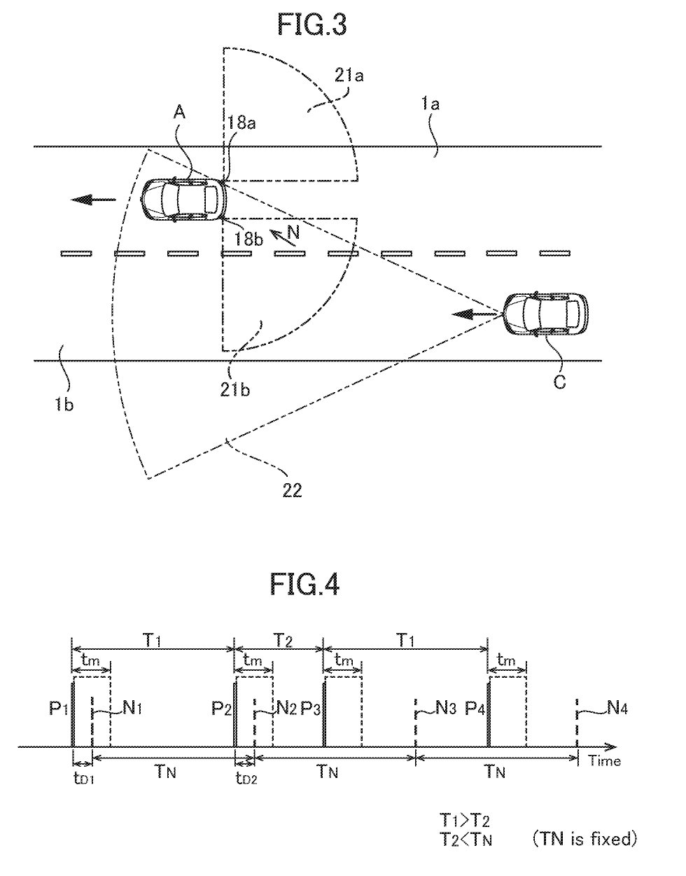

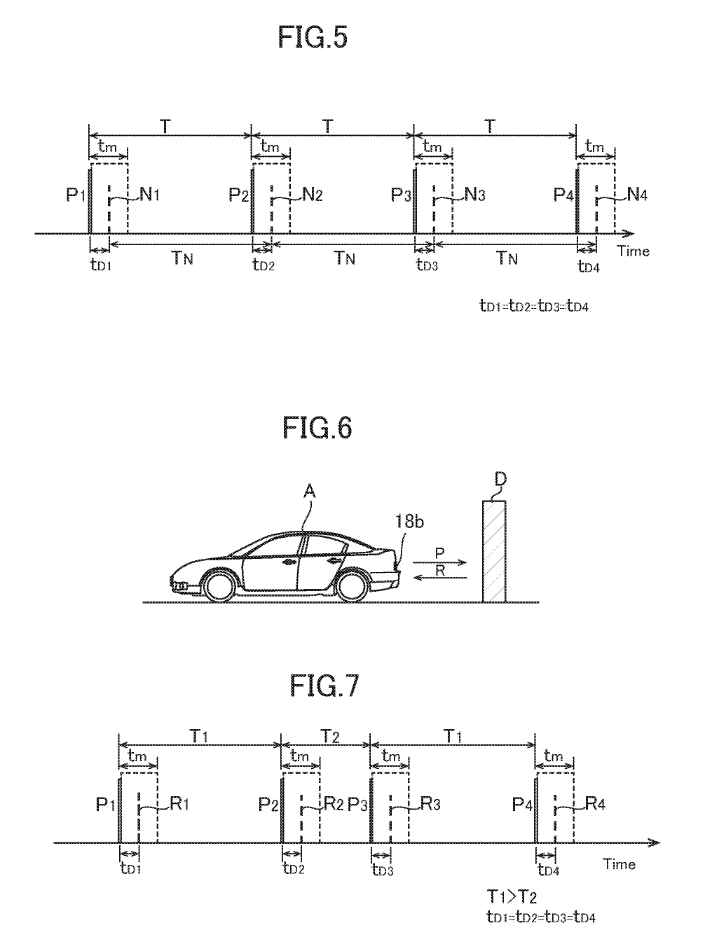

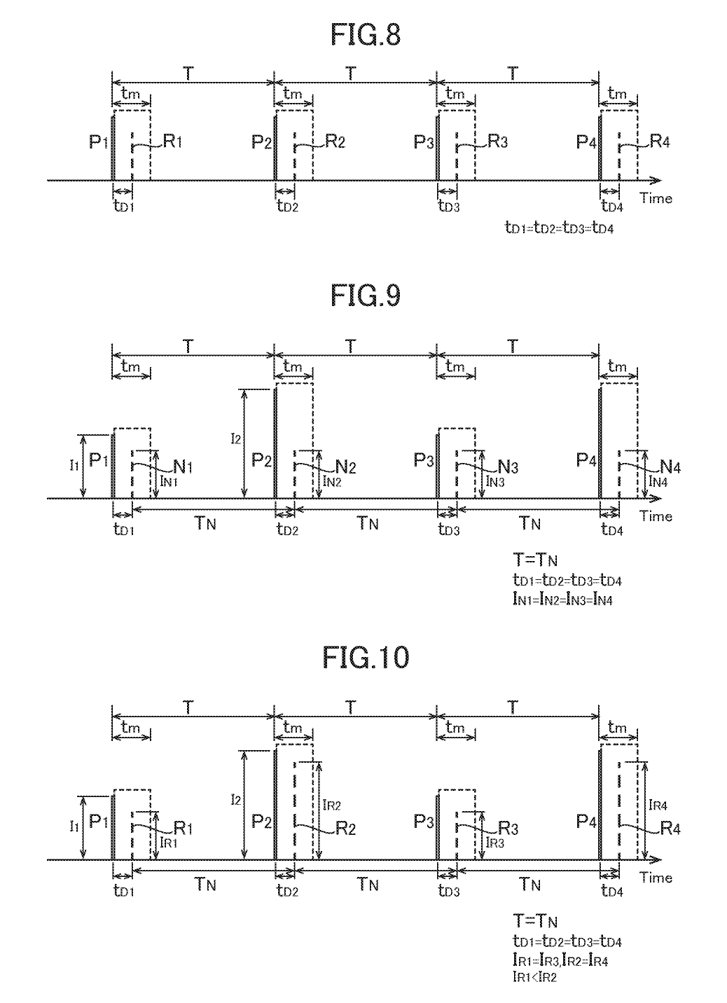

Next, with reference to FIGS. 3 to 8, operations of a radar device according to the present embodiment will be described. FIG. 3 is an illustrative diagram depicting a driving condition of a vehicle on which a radar device according to one embodiment of the present invention is mounted, together with another vehicle. FIG. 4 is an illustrative diagram of a measurement by the radar device in the condition of FIG. 3. FIG. 5 is an illustrative diagram of a measurement by the radar device according to a comparative example. FIG. 6 is an illustrative diagram depicting a condition of a vehicle, on which a radar device is mounted, the vehicle being positioned near a fixed structural object on a road. FIG. 7 is an illustrative diagram of a measurement by the radar device under the condition shown in FIG. 6. FIG. 8 is an illustrative diagram of a measurement by the radar device according to a comparative example.

First, with reference to FIGS. 3 to 5, description will be made on an operation of the radar device under a condition where a vehicle having an inventive radar device mounted thereon and a behind vehicle are running on separate, parallel lanes. Similar to FIG. 2, FIG. 3 depicts the condition where the vehicle A (the leading vehicle), on which the radar device 10 is mounted, is running on the lane 1a, and the behind vehicle C, on which a similar radar device is mounted, is running on an adjacent lane 1b distant from the vehicle A by a predetermined distance. Further, the behind vehicle C is in a position outside the measurement range 21b of the radar device 10 of the vehicle A, but the vehicle A is in a position within the measurement range 22 of the radar device of the behind vehicle C.

FIG. 4 depicts a condition where the radar device 10 of the vehicle A is performing a measurement using the left side rear antenna 18b. As shown in FIG. 4, the radar device 10 of the vehicle A transmits each of measurement waves P (P₁, P₂, P₃, P₄, . . . ) of a predetermined carrier frequency which last for a predetermined transmission period from the rear antenna 18b at every certain transmission interval (measurement interval). In the present embodiment, the controller 12 outputs a transmission command to the transmitting and receiving part 14 so that the measurement interval of each of the measurement waves P may be changed with time. In this example, a measurement interval T₁ and a measurement interval T₂ (T₂<T₁) are repeated alternately (for example, T₁=80 milliseconds, and T₂=50 milliseconds).

Specifically, the transmission interval T₁ is provided between the measurement wave P₁ and the measurement wave P₂, but the next transmission interval to the next measurement wave P₃ is changed to the measurement interval T₂, and further, the transmission interval to the next measurement wave P₄ is changed (returned) to the measurement interval T₁, and alternation between the measurement interval T₁ and the measurement interval T₂ is repeated at every transmission from then on.

In addition, a predetermined measurement period tm from the time when each of the measurement waves P is transmitted is set in a receiving window, and the transmitting and receiving part 14 is configured to receive each of the reflection waves only within the measurement period tm. In the example shown in FIG. 3, since another vehicle is not present within the measurement range 21b, the sending and receiving part 14 does not receive any reflection wave within the measurement period tm in each of the measurements.

On the other hand, the behind vehicle C has a similar radar device mounted thereon, and transmits each of measurement waves (noise waves) N (N₁, N₂, N₃, N₄, . . . ) at every fixed predetermined transmission interval T_{N}. In the example shown in FIG. 4, it is assumed as T_{N}=T₁. As shown in FIG. 4, a noise wave N₁ and a subsequent noise wave N₂ arrive at the vehicle A within the respective measurement periods tm of the measurement wave P₁ and the subsequent measurement wave P₂, and thus, the radar device 10 receives the noise waves N₁, N₂ as detection waves. In addition, delay time t_{D1}, t_{D2} from the time when the measurement waves P₁, P₂ are transmitted to the time when the noise waves N₁, N₂ are received will become approximately the same.

However, since the measurement interval T₂ and the transmission interval T_{N} are not equal (T₂<T_{N}) with each other, the third noise wave N₃ does not arrive at the vehicle A within the measurement period tm of the third measurement wave P₃. In addition, the fourth noise wave N₄ does not arrive at the vehicle A within the measurement period tm of the fourth measurement wave P₄. Thus, the transmitting and receiving part 14 of the radar device 10 does not receive any detection wave within the respective measurement periods tm corresponding to the measurement waves P₃, P₄.

The controller 12 of the radar device 10 receives a processed signal from the transmitting and receiving part 14 at every measurement event, and based on the processed signal, determines as to whether the detection wave is received or not. Specifically, the controller 12 determines as to whether any particular detection wave is received or not in most recent successive measurement events of a predetermined number of times (three times or more). In addition, if the measurement in which the particular detection wave is received (for example, each of the measurements by the measurement waves P₁, P₂) and the measurement in which the particular detection wave is not received (for example, the measurement by the measurement wave P₃) are both included in the measurement events of the predetermined number of times, the controller 12 determines the received detection waves (for example, the noise waves N₁, N₂) as the noise waves but not the reflection waves.

The controller 12 of the radar device 10 outputs the relative distance and the relative speed etc. of the target calculated based on the detection waves (i.e. the reflection waves) which were not determined as the noise waves to other systems within the vehicle such as the obstacle detecting device 30 as information of the target. However, the controller 12 does not output the information of the distance and/or speed etc. similarly calculated based on the detection waves (i.e. noise waves) which were determined as the noise waves to other systems.

Further, in FIG. 3, if there is another vehicle running within the measurement range 21b other than the behind vehicle C, the radar device 10 of the vehicle A may receive the noise wave from the vehicle C and the reflection wave from the another vehicle within the same measurement period tm. In this case, since the radar device 10 receives the reflection waves from the another vehicle in the predetermined successive measurement events, the reflection waves from the another vehicle are not determined as the noise waves, and on the other hand, the detection waves from the behind vehicle C which are not received successively in the predetermined successive measurement events may be determined as the noise waves.

As described above, in accordance with the present embodiment, the reflection waves generated by the measurement waves are discriminated from the noise waves which arrive on a fixed cycle, so that it is possible to avoid the erroneous detection of the target due to the noise waves to thereby avoid the erroneous activation of the obstacle detection device 30.

Further, FIG. 5 depicts a comparative example (an example of a conventional device) in which the measurement interval T is fixed, and as shown in FIG. 5, each of the measurement waves P (P₁, P₂, P₃, P₄, . . . ) is transmitted at every fixed measurement interval T. Here, it is assumed that the transmission interval T_{N} is equal to the transmission interval T. In this way, when the measurement interval T of the radar device and arriving interval of the noise waves N (the transmission interval T_{N}) are the same, there may be a case wherein each of the noise waves (N₁, N₂, N₃, N₄, . . . ) may be received as the detection wave in the respective measurement periods tm corresponding to each of the measurement waves P. In this case, in the comparative example where the measurement period is not configured to be changed with time as in the present embodiment, the noise waves cannot be differentiated from the reflection waves.

Next, referring to FIGS. 6 to 8, descriptions will be made on operations of a radar device under a condition where a vehicle having a radar device of the present invention mounted thereon is positioned near a fixed structural object on a road. FIG. 6 depicts a condition where a vehicle A (the vehicle having an embodiment of the present invention is mounted thereon) is stopped, or moving forward or backward at a slow speed near the fixed structural object D on the road (for example, a wall etc.). Here, the radar device 10 transmits the measurement waves P from the left side rear antenna 18b and receives the reflection waves R from the structural object D.

As shown in FIG. 7, similar to the case shown in FIG. 4, each of the measurement waves P (P₁, P₂, P₃, P₄, . . . ) are transmitted at timings wherein the measurement intervals T₁ and T₂ (T₁>T₂) are alternated with time. In each of the measurement events, the transmitting and receiving part 14 receives each of the reflection waves R (R₁, R₂, R₃, R₄, . . . ) attributed to each of the measurement waves P within the respective measurement periods tm corresponding to each of the measurement waves P (P₁, P₂, P₃, P₄, . . . ). Here, at each of the measurement events, since the relative distance between the vehicle A and the structural object D is approximately the same, each of the reflection waves R is received after approximately same delay time t_{D} (t_{D1}=t_{D2}=t_{D3}=t_{D4}).

Thus, in accordance with the present embodiment, even though the measuring intervals are changed with time, all of the reflection waves R (R₁, R₂, R₃, R₄, . . . ) derived from respective ones of the measurement waves P are received in respective ones of the measurement periods tm corresponding to respective ones of the measurement waves P, so that the reflection waves R are not erroneously detected as the noise waves. Therefore, the radar device 10 can calculate the relative distance and the relative speed etc. between the vehicle A and the structural object D based on the measurement waves P and the reflection waves R to output the information of the target (the structural object D) to the obstacle detection device 30.

Further, FIG. 8 depicts a comparative example (an example of a conventional device) in which the measurement interval T is fixed, and as shown in FIG. 8, when respective ones of the reflection waves R (R₁, R₂, R₃, R₄, . . . ) derived from respective ones of the measurement waves P (P₁, P₂, P₃, P₄, . . . ) are received, these reflection waves R are received in respective ones of the measurement periods tm corresponding to the respective measurement waves P. Thus, also in the comparative example, similar to the present embodiment, when the reflection waves instead of the noise waves are received, it is possible to calculate the relative distance and the relative speed etc. between the vehicle and the structural object D to output the information of the target (the structural object D) to the obstacle detection device.

Further, in the embodiment described above, although alternation of the measurement intervals T₁ and T₂ is repeated with time, but the embodiment may not be limited to such alternation of two intervals, but the measurement interval (>the measurement period tm) may be changed with time, with a random length, or three or more intervals of different lengths may be alternately repeated.

In addition, in the embodiment described above, although the measurement interval is changed at every transmission of each of the measurement waves P, and a reception of the detection wave during the measuring period tm from the time when the measurement wave P is transmitted is provided as one measurement, the embodiment is not limited to this measurement, but it may be such that identical measurement intervals are maintained during the transmission of each of the measurement waves P of a predetermined plurality number of times (for example, two times) (that is to say, the measurement interval is not changed during the transmission of each of the measurement waves P of a plurality number of times), a plurality number of transmission and reception is provided as one measurement, and the measurement interval is changed at every transmission of a plurality number of times. In other words, the mode of measurement may be configured such that a group of transmission and reception of plurality number of times is provided as one measurement, and the measurement interval is changed at every group of transmission and reception.

Further, in the above embodiment, the measurement interval is changed with time so that the periodic noise wave will not be received by a measurement of at least once during the measurements of a predetermined number of times, but there may be a case that the noise wave is received in all of the measurements of the predetermined number of times even if the measurement interval is changed with time. Therefore, the embodiment described above may be modified as in the followings. Specifically, in each of the measurements, the controller 12 may calculate the delay time t_{D} or the relative distance based on the processed signal, and when the delay time t_{D} or the relative distance does not meaningfully match in the successive measurement events of a predetermined plurality number of times (for example, three times), determine the received detection wave as the noise wave.

As described above, in accordance with the present embodiment, length of the measurement intervals (T₁, T₂) is changed with time. Thus, the radar device 10 receives each of the reflection waves R, which is what returned from the target because of the measurement wave P reflected by the target, on unequal interval instead of on a fixed interval in terms of time, according to the change of the length of the measurement interval. On the other hand, if the measurement intervals are unequal in terms of time among a plurality of measurement events, the noise wave N which arrives on a fixed period (the interval T_{N}) from outside may be received in one measurement, but not in other measurement, and thus, there may exist both the measurement event where the reflection wave is received and the measurement event where the reflection wave is not received. Stating differently, there may be produced a condition, in which a delay time for receiving the noise wave N with respect to timing when the measurement wave P is transmitted meaningfully deviated. Thus, in accordance with the present embodiment, it is possible to determine as to whether the detection wave is the noise wave N which arrives on a periodic basis or not to thereby prevent the erroneous detection of the noise wave N, by monitoring whether the reception wave (detection wave) is received or not, or by monitoring the delay time for reception.

In addition, in accordance with the present embodiment, when the measurement wherein the detection wave is received and the measurement wherein the detection wave is not received are both included in the successive measurement events of at least three times in which the length of the measurement intervals (T₁, T₂) is changed, the controller 12 determines the received detection wave as the noise wave. Thus, in accordance with the present embodiment, the reflection waves R are received in all of the measurement events, in the measurement events of at least three times in which the lengths of the measurement intervals are changed, but since each of the noise waves N which arrives on a fixed cycle is not always received in all of the measurement events, it is possible to easily determine as to whether the detection wave is the noise wave N or not, by monitoring the measurements of a predetermined number of times.

Next, with reference to FIGS. 9 and 10, operations of a radar device according to the second embodiment will be described. FIG. 9 is an illustrative diagram of a measurement by a radar device under the condition of FIG. 3, and FIG. 10 is an illustrative diagram of a measurement by a radar device under the condition of FIG. 6. In the second embodiment, configurations are such that the radar device 10 is operated to change the signal strength of the measurement waves P with time.

First, based on FIG. 9, an operation of the radar device 10 in the condition where the vehicle A having a radar device of one embodiment of the present invention mounted thereon and the behind vehicle C running on a different but parallel lane (refer to FIG. 3) will be described. As shown in FIG. 9, the radar device 10 of the vehicle A transmits the measurement waves P (P₁, P₂, P₃, P₄, . . . ) from the rear antenna 18b at every fixed measurement interval T (for example, T=60 milliseconds). In the present embodiment, the controller 12 outputs a transmission command to the transmitting and receiving part 14 so that the signal strengths of the measurement waves P are changed with time. In this example, the measurement waves P (P₁, P₃, . . . ) of a low signal strength I₁ and the measurement waves P (P₂, P₄, . . . ) of a high signal strength I₂ (>I₁) are transmitted alternately. Further, the signal strength of each of the measurement wave P is a mean signal strength (power) or the maximum signal strength in the transmission period of each of the measurement waves P.

In the example shown in FIG. 3, since another vehicle etc. is not present within the measurement range 21b, the transmitting and receiving part 14 does not receive any reflection wave within the measurement period tm in each of the measurement events. However, the behind vehicle C is transmitting from a similar radar device the measurement waves (noise waves) N (N₁, N₂, N₃, N₄, . . . ) at every predetermined fixed transmission interval T_{N}. In the example of FIG. 9, it is assumed that T_{N}=T.

Therefore, as shown in FIG. 9, the noise waves N (N₁, N₂, N₃, N₄, . . . ) may arrive at the vehicle A within the measurement period tm of the measurement waves P (P₁, P₂, P₃, P₄, . . . ), and the radar device 10 receives the noise waves N (N₁, N₂, N₃, N₄, . . . ) within the measurement period tm of the measurement waves P (P₁, P₂, P₃. P₄, . . . ). In addition, the delay time t_{D} from the time when each of the measurement waves P (P₁, P₂, P₃. P₄, . . . ) is transmitted to the time when each of the noise waves N (N₁. N₂, N₃, N₄, . . . ) is received becomes approximately the same (t_{D1}=t_{D2}=t_{D3}=t_{D4}).

However, although the signal strength of each of the measurement waves P is changed with time, the signal strength of each of the received noise waves N is approximately the same. Specifically, the noise waves N are measurement waves transmitted from the behind vehicle C, and have a fixed signal strength which is not changed with time (I_{N1}=I_{N2}=I_{N3}=I_{N4}).

The controller 12 of the radar device 10 receives a processed signal from the transmitting and receiving part 14 at every measurement event, and based on the processed signal, determines as to whether the detection wave is received or not. Specifically, the controller 12 compares, in most recent successive measurement events of predetermined number of times (two times or more), the signal strength of the detection waves in a pair of detection waves (for example, noise waves N₁ and N₂, noise waves N₂ and N₃, noise waves N₃ and N₄ and so on) received by a pair of successive measurement events of a predetermined number of times (two times in the case of FIG. 9) by the transmission of the measurement waves P of different signal strength (for example, the measurement waves P₁ and P₂, the measurement waves P₂ and P₃, the measurement waves P₃ and P₄ and so on). Then, when the signal strength of a predetermined number of the detection waves in the pair are approximately the same, determines the received detection wave as the noise wave.

In the example shown in FIG. 9, in each of the pairs (noise waves N₁ and N₂, noise waves N₂ and N₃, noise waves N₃ and N₄), the signal strength of two detection waves are approximately the same (I_{N1}=I_{N2}=I_{N3}=I_{N4}), so that the controller 12 determines these detection waves as the noise waves.

The controller 12 of the radar device 10 does not output the information such as the distance and/or the speed etc. similarly calculated based on the detection waves determined as the noise waves (i.e. the noise waves) to other systems. Thus, also in the present embodiment, it is possible to avoid the erroneous detection of the target based on the noise waves which arrive on a fixed cycle to thereby avoid the erroneous activation of the obstacle detection device 30.

Next, referring to FIG. 10, description will be made on an operation of the radar device 10 in the case wherein the vehicle having a radar device in accordance with one embodiment of the present invention is positioned near the fixed structural object on the road (refer to FIG. 6). As shown in FIG. 6, the radar device 10 of the vehicle A positioned near the fixed structural object D on the road transmits the measurement waves P from the left side rear antenna 18b and receives the reflection waves R from the structural object D.

As shown in FIG. 10, similar to the case in FIG. 9, the signal strength of each of the measurement waves P (P₁, P₂, P₃, P₄, . . . ) is changed with time, but each of the measurement waves P is transmitted at a fixed measurement interval T. In each of the measurement events, the transmitting and receiving part 14 receives the reflection waves (R₁, R₂, R₃, R₄, . . . ) derived from the measurement waves P within the respective measurement periods tm for the measurement waves P (P₁, P₂, P₃, P₄, . . . ). Here, at each of the measurement events, since the relative distance between the vehicle A and the structural object D is approximately the same, each of the reflection waves R is received after approximately the same delay time t_{D} (t_{D1}=t_{D2}=t_{D3}=t_{D4}).

In the present embodiment, since the signal strengths of the measurement waves P are changed with time, the received signal strengths of the reflection waves R (R₁, R₂, R₃, R₄, . . . ) derived from the measurement waves P change with time in accordance with the signal strengths of the corresponding measurement waves P (P₁, P₂, P₃, P₄, . . . ). As described above, the controller 12 of the radar device 10 functions to compare the signal strengths of a pair of detection signals (for example, reflection waves R₁ and R₂, reflection waves R₂ and R₃, reflection waves R₃ and R₄ and so on) received by a pair of successive measurement events of a predetermined number of times (two times in the case of FIG. 10) by the transmission of the measurement waves P of different signal strength (for example, the measurement waves P₁ and P₂, the measurement waves P₂ and P₃, the measurement waves P₃ and P₄ and so on), and when these signals are of approximately the same strengths, determines the received detection waves as the noise waves.

However, in the case of FIG. 10, since the signal strengths of the pair of detection waves (reflection waves R) are meaningfully different (I_{R1}<I_{R2}, I_{R2}>I_{R3}, I_{R3}<I_{R4}) in accordance with the change of the signal strengths of the measurement waves P, these detection waves are determined as the reflection waves but not the noise waves. Thus, the radar device 10 can output the relative distance and the relative speed etc. between the vehicle A and the structural object D calculated based on the measurement waves P and the reflection waves R, as the information of the target (structural object D), to the obstacle detection device 30.

Further, in the embodiment described above, although the device is constructed such that the respective measurement waves P of the signal strength I₁ and the signal strength I₂ are transmitted alternately, the construction may not be limited to these features, but the device may be constructed such that the signal strength is changed with time randomly, or that groups of signals each comprising three or more signals having different signal strengths may be alternatively transmitted as the measurement waves P.

In addition, in the embodiment described above, although the measurement interval T is fixed, the device may not necessarily be limited to the features, but the measurement interval T may be changed with time as in the embodiment described with reference to FIGS. 4 and 7.

Further in the embodiment described above, the signal strength is changed at every transmission of the measurement wave P, and the reflection wave based on the measurement wave P of one transmission (or a noise wave) received during the measurement period tm is treated as providing one measurement, however the embodiment may not necessarily be limited to the features, but it may be configured such that identical signal strength is maintained during the transmission of the measurement waves P in a predetermined plurality number of times (for example, two times) (that is to say, the signal strength is not changed during the transmission of the measurement waves P in a plurality number of times), a plurality number of transmission and reception may be treated as providing one measurement, and the signal strength may be changed at every transmission of a plurality number of times. Describing in a different way, the embodiment may be configured such that a group of the transmission and reception of a plurality number of times is treated as providing one measurement, and the signal strength is changed at every group of transmission and reception.

As described above, in the present embodiment, the signal strengths of the reflection waves R from the target change in accordance with the change in the signal strengths (I₁, I₂) of the measurement waves P, but the signal strengths (I_{R}) of the noise waves N do not change even under the change of the signal strengths of the measurement waves P. Thus, in accordance with the present embodiment, it is possible to determine as to whether the detection waves are the noise waves N or not to thereby prevent any erroneous detection of the noise waves N, by monitoring the signal strengths of the reception waves (detection waves) with respect to the signal strengths of the measurement waves P.

Further, in the present embodiment, when the signal strengths of the pair of detection waves received by the successive measurement events of at least two times by the transmission of the measurement waves P of different signal strengths (I₁, I₂) are the same, the controller 12 determines the received pair of detection waves as the noise waves N. Thus, in accordance with the present embodiment, in the pair of measurements of at least two times in which the signal strengths of the measurement waves P are changed, the signal strengths of the received pair of the reflection waves R are changed in accordance with the change of the signal strengths of the measurement waves P, but since the signal strengths of the received pair of the noise waves N are not changed in accordance with the change of the signal strengths of the measurement waves P, it is possible to easily determine as to whether the detection waves are the noise waves N or not, by monitoring the measurements of a predetermined number of times.

### LIST OF REFERENCE NUMERALS

1a, 1b: lane
10: radar device
12: controller
14: transmitting and receiving part
16: forward antenna
18a, 18b: rear antenna
20, 21a, 21b, 22: measurement range
A: vehicle
B: leading vehicle
C: behind vehicle
D: fixed structural object
P (P₁, P₂, P₃, P₄): measurement wave
R (R₁, R₂, R₃, R₄): reflection wave
N (N₁, N₂, N₃, N₄): noise wave
T, T₁, T₂: measurement interval
T_{N}: interval
tm: measurement period
t_{D} (t_{D1}, t_{D2}, t_{D3}, t_{D4}): delay time

What is claimed is:

1. A radar device, adapted to be mounted on a vehicle, for repeatedly performing measurements of a target at every predetermined measurement interval, comprising
a transmitting and receiving part for, in each of the measurement events, transmitting a measurement wave which lasts for a predetermined transmission period shorter than the measurement interval within the measurement interval, and receiving a reflection wave thereof as a detection wave and
a controller for controlling the transmitting and receiving part,
wherein the controller is configured to control the transmitting and receiving part so that at least one of a length of each of the measurement intervals and a signal strength of each of the measurement waves is changed with time.

2. The radar device according to claim 1 wherein the controller is configured to control the transmitting and receiving part so that the length of each of the measurement intervals is changed with time,
said controller is configured such that, when results of successive measurement events of at least three times in which the lengths of the measurement intervals are changed include both a measurement result in which the detection wave is received and a measurement result in which the detection wave is not received, the controller determines the received detection wave as a noise wave.

3. The radar device according to claim 1 wherein the controller is configured to control the transmitting and the receiving part so that the signal strengths of the measurement waves are changed with time,
said controller is configured such that, when the signal strengths of a pair of the detection waves received in successive measurement events of at least two times by the transmission of each of the measuring waves having different signal strength are the same, the controller determines the received pair of detection waves as the noise waves.

4. The radar device according to claim 2, wherein the noise wave is an electric wave transmitted on a fixed cycle from another vehicle or from a fixed structural object on a road.

5. The radar device according to claim 3, wherein the noise waves are electric waves transmitted on a fixed cycle from another vehicle or from a fixed structural object on a road.
